(19) United States
(12) Patent Application Publication
(10) Pub. No.: US 2006/0224869 A1
(43) Pub. Date: Oct. 5, 2006

(54) Combination of forwarding/bypass network with history file

(76) Inventors: Brian King Flachs, Georgetown, TX (US); Brad William Michael, Cedar Park, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/095,908

(22) Filed: Mar. 31, 2005

(51) Int. Cl. G06F 9/44

(52) U.S. Cl. 712/228

(57) ABSTRACT

An apparatus, a method, and a processor are provided for recovering the correct state of processor instructions in a processor. This apparatus contains a pipeline of latches, a register file, and a replay loop. The replay loop repairs incorrect results and inserts the repaired results back into the pipeline. A state machine detects incorrect results within the pipeline and sends the incorrect results to the replay loop. A correction module on the replay loop repairs the incorrect results and transmits the repaired results back into the pipeline. When an incorrect result enters the replay loop, a flush operation: ceases other operations within the pipeline; flushes the rest of the data results in the pipeline to the replay loop; opens the pipeline for the repaired results to be inserted; and eliminates any operations within the processor that would utilize the incorrect results.

### FIELD OF THE INVENTION

The present invention relates generally to recovering the correct state of processor instructions, and more particularly, to the utilization of a forwarding/bypassing network to recover the correct state of processor instructions before the execution of failed instructions.

### DESCRIPTION OF THE RELATED ART

To ensure the proper operation of a processor, only correct results can be committed to the architectural machine state. The commitment of incorrect results can cause many problems with processors. Inaccurate data and/or incorrect instructions can lead to the commitment of incorrect results. Furthermore, in the presence of late occurring exceptions (such as error correction code (ECC) errors of loads), the correctness of results may not be known for many cycles. This indicates that processor operations must be stalled while correcting late occurring exceptions before their commitment. The ultimate goal is the repair of incorrect results before commitment without compromising the area on the chip or the speed of the processor.

The prior art features three basic techniques to recover the correct state of the processor prior to the execution of failed instructions. The first method involves the use of history files. These history files store a previous state of the register file (the register file stores the committed results). When the processor detects an incorrect instruction, the history files write over the incorrect instruction with a previous state of the register file. Subsequently, a restart operation rewrites the correct instruction to the register file. The additional “register file read ports,” which are necessary to create the history files, take up a significant amount of area on the chip. Furthermore, a forwarding network to load the history files into the register file also consumes area on the chip.

A second method involves the process of register renaming. This process stores incorrect results in a larger register file or auxiliary register file until the correct result is committed that replaces it. These large register files also consume a large area of the chip. Pipeline extension is another prior art method to ensure that correct results are committed. With this method, the instructions proceed down a pipeline until the instructions are executed. By extending the pipeline, the number of cycles is extended, and failed instructions can be detected before execution. However, this method delays the storage of results in the register file, which slows down the processor.

FIG. 1 depicts a conventional pipeline apparatus 100 that recovers the correct state of the processor prior to the execution of a failed instruction. This apparatus recovers the correct state of the processor by extending the pipeline. Latches 106, 110, 114, and 118 have a multiplexer (“MUX”) 150 connected on top of them, whereas latches 120, 122, 124, 126, 128, 130, 132, 134, and 136 do not have a MUX connected to them. Input lines 102, 104, 108, 112, and 116 come from different execution units (shown in FIG. 5) within the processor. The execution units feed these input lines into different stages of the pipeline based upon the latency of computing the result. An arbitrary number of execution units feed the pipeline and input each result at an arbitrarily chosen stage.

Input lines 102 and 104 feed latch 106 in stage 1 of this pipeline 100. MUX 150 connected to the latch allows the selected result 102 or 104 to be written to latch 106. This means that MUX 150 selects one of the input lines. The result in latch 106 moves to latch 110 in stage 2 of this pipeline. MUX 150 connected to latch 110 can also write the result from input line 108 to latch 110 in stage 2; therefore, MUX 150 selects which result to write to latch 110. In stage 3, MUX 150 connected to latch 114 writes either the result from latch 110, or the result from input line 112, to latch 114. In stage 4, MUX 150 connected to latch 118 either writes the result from latch 114, or the result from input line 116, to latch 118. Each stage of this pipeline corresponds to one clock cycle of the processor.

From latch 118, the results pass through pipeline 100 without input lines. The result passes through latches 120, 122, 124, 126, 128, and 130. These stages of the pipeline (5-10) produce necessary delays that enable the detection and correction of any incorrect results. Basically, the extra stages allow the processor to examine the results in the pipeline and correct them, if necessary. In this pipeline 100, the processor takes 5 cycles (stages 5-10) to detect an incorrect result and repair the incorrect result. From latch 130, the results are transmitted to latch 134 and register file write latch 132, simultaneously. Register file write latch 132 commits the result to the register file (not shown). Latch 134 transmits the result to latch 136, where MUX 140 forwards the data to other places within the processor. In this conventional pipeline apparatus 100, the incorrect results are repaired before they are committed by register file write latch 132, however, the large number of latches within the pipeline 100 and the corresponding delay due to the large number of stages constitute the drawback of this design. Due to the large number of latches, MUX 140 must be larger in size. In addition, MUX 140 forwards a large amount of data, which adversely affects the speed of the processor.

Some conventional designs (including FIG. 1) allow the incorrect result to be corrected before normal machine operation resumes, which adversely affects the speed of the processor. Furthermore, in these conventional designs, care must be taken to ensure that the result to be corrected is still the architectural state of some register. In other words, if a register is set to an incorrect result, and then set to the result of some second instruction, the register must not be updated with a corrected result for the first instruction. In this situation, the correction of the failed instruction may lead to the storage of an incorrect result. A method and an apparatus to ensure correct results in a processor, without adversely affecting the area on the chip or the speed of the processor, would be a vast improvement over the prior art methods and apparatuses.

### SUMMARY OF THE INVENTION

The present invention provides an apparatus, a method, and a processor for recovering the correct state of processor instructions in a processor. Incorrect results in a processor must be repaired before they are committed to memory or forwarded to other areas of the processor. This apparatus contains a pipeline of latches, a register file, and a replay loop. The replay loop repairs incorrect results and inserts the repaired results back into the pipeline. A state machine detects incorrect results within the pipeline and sends the incorrect results to the replay loop. A correction module on the replay loop repairs the incorrect results and transmits the repaired results back into the pipeline. When an incorrect result enters the replay loop, a flush operation: ceases other operations within the pipeline; flushes the rest of the data results in the pipeline to the replay loop; opens the pipeline for the repaired results to be inserted; and eliminates any operations within the processor that would utilize the incorrect results. This ensures correct results within the processor, while saving area on the chip and enhancing the speed of the processor.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a conventional pipeline apparatus that recovers the correct state of the processor prior to the execution of a failed instruction;

FIG. 2 is a block diagram depicting a modified pipeline apparatus that utilizes a replay path to recover the correct state of the processor prior to the execution of a failed instruction;

FIG. 3 is a block diagram illustrating the replay loop of the modified pipeline apparatus;

FIG. 4 is a flow chart illustrating the modified method to recover the correct state of the processor prior to the execution of a failed instruction by using a replay path; and

FIG. 5 is a block diagram illustrating a central processing unit within a computer.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are implemented in hardware in order to provide the most efficient implementation. Alternatively, the functions may be performed by a processor such as a computer or an electronic data processor in accordance with code such as computer program code, software, and/or integrated circuits that are coded to perform such functions, unless indicated otherwise.

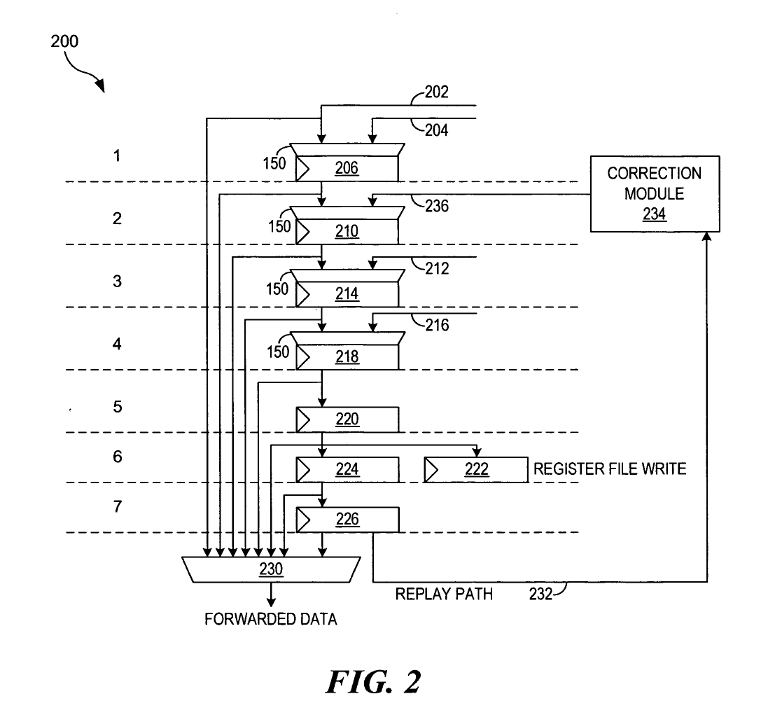

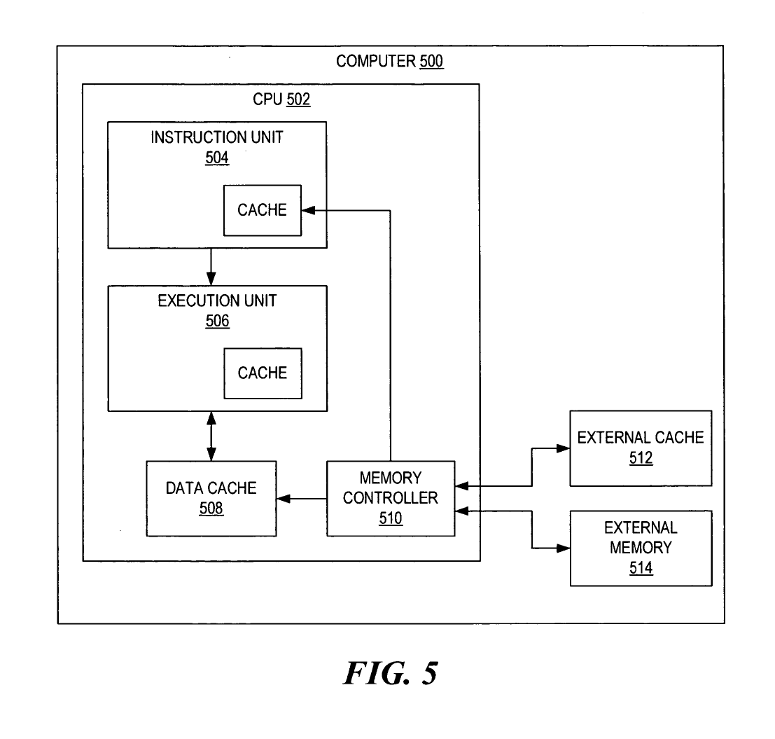

FIG. 2 depicts a modified pipeline apparatus 200 that utilizes a replay path to recover the correct state of the processor prior to the execution of a failed instruction. Latches 206, 210, 214, and 218 have a MUX 150 connected on their top, whereas latches 220, 222, 224, and 226 do not have a MUX connected to them. Input lines 202, 204, 212, and 216 come from different execution units within the processor, such as load units or an adder. The execution units (shown in FIG. 5) feed these input lines into different stages of the pipeline based upon the latency of computing the result. An arbitrary number of execution units feed the pipeline and input each result at an arbitrarily chosen stage.

Input lines 202 and 204 feed latch 206 in stage 1 of this pipeline 200. MUX 150 connected to latch 206 allows selected result 202 or 204 to be written to latch 206. This means that MUX 150 selects one of the input lines. The result in latch 206 moves to latch 210 in stage 2 of this pipeline. Then, latch 210 transmits the result to latch 214 in stage 3 of this pipeline. MUX 150 connected to latch 214 can also write the result from input line 212 to latch 214 in stage 3; therefore MUX 150 selects which result to write to latch 214. In stage 4, MUX 150 connected to latch 218 writes either the result from latch 214, or the result from input line 216, to latch 218. Each stage of this pipeline corresponds to one clock cycle of the processor. The number of stages in FIG. 2 depends upon the implementation of this modified pipeline apparatus, and more specifically, the latencies involved with this apparatus. FIG. 2 is only an example of a preferred embodiment and does not limit the present invention to this embodiment.

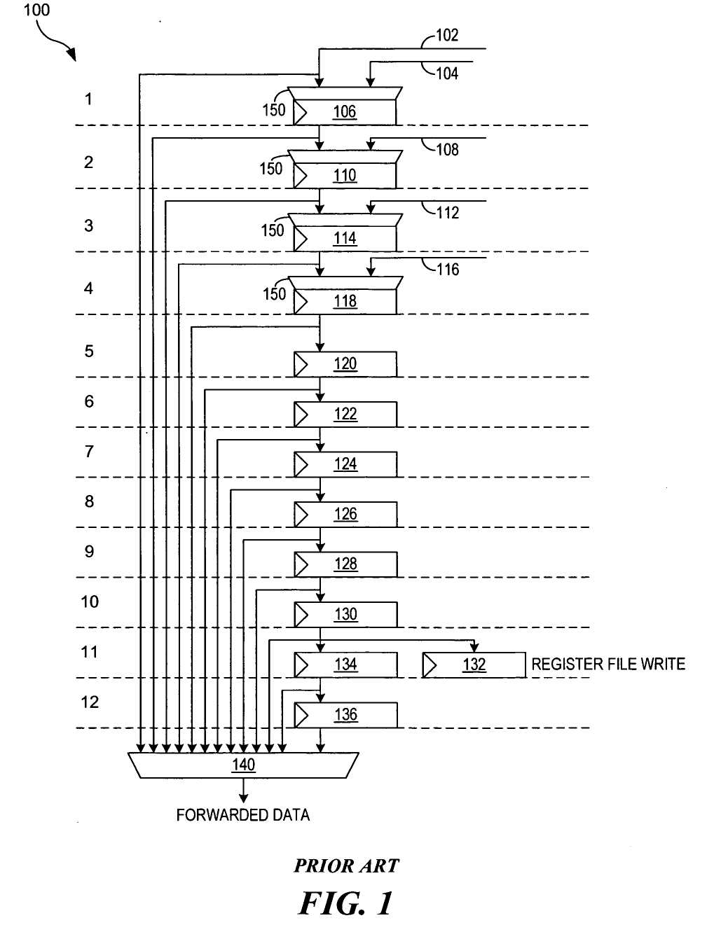

From latch 218, the results pass through pipeline 200 without input lines through latch 220. The processor detects an incorrect instruction in stages 5-7 of the pipeline. This number of stages matches the latency to determine an incorrect instruction and the latency to determine the correct value. In contrast with FIG. 1, the incorrect instruction does not have to be repaired in pipeline 200. From latch 220, the instructions are transmitted to latch 224 and register file write latch 222, simultaneously. Register file write latch 222 commits the result to the register file (not shown). Latch 224 transmits the result to latch 226, where a MUX 230 forwards the data to other places within the processor, such as execution units or system memory. The processor does not repair the incorrect instructions in the pipeline as shown in FIG. 1.

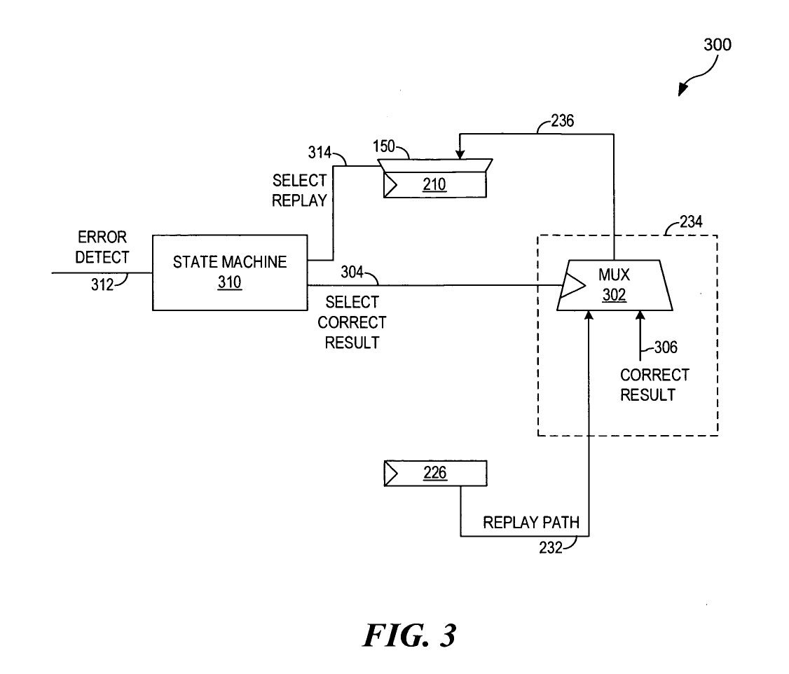

Rather, replay path 232 is a novel feature of the present invention. If the processor detects an incorrect result within pipeline 200, the processor begins the recirculation of this result. In a preferred embodiment, a memory controller (shown in FIG. 5) detects the incorrect result. Accordingly, the processor transmits the incorrect result from latch 226 to replay path 232. Correction module 234 repairs the incorrect result before inserting the correct result back into pipeline 200. (described in further detail by FIG. 3). Therefore, correction module 234 transmits the repaired result on output line 236 to latch 210. MUX 150 connected to latch 210 then selects the result from output line 236 and the repaired result travels down pipeline 200. The stage that correction module 234 feeds the repaired result into the pipeline is dependent upon the latency of repairing the incorrect instruction. At stage 6, the repaired result is committed to register file write latch 222, again. This indicates that the correct result replaces the incorrect result in the register file (not shown). A state machine (shown in FIG. 3) controls the operation of this modified pipeline 200. The state machine: knows the latency values of replay path 232 and pipeline 200; detects the incorrect instruction or result; and controls the timing of these operations. The state machine can be a device or a component.

The present invention utilizes a pipeline flush to insert the repaired result back into pipeline 200. Other operations within the pipeline cease when the incorrect instruction enters replay path 232. In addition, when the replay path is turned on, all instructions in the pipeline are flushed out with the incorrect result. This means that the following instructions within the pipeline follow the incorrect instruction down replay path 232. The number of instructions that follow the incorrect instruction down replay path 232 matches the latency of the replay process. Furthermore, the execution units sending results to this pipeline are shut down during this period of time. This process assures that correction module 234 correctly inserts the repaired result in pipeline 200. The state machine (not shown) controls this flush operation to ensure that all of the dependency issues are resolved. By flushing the remaining results within pipeline 200 down replay path 232, the results following the incorrect result are not committed before the repaired result. This means that pipeline apparatus 200 commits the repaired result before any dependent, subsequent results. In addition, the flush operation eliminates any instructions within the processor that would consume the incorrect data produced by the recoverable exception. The present invention handles the correction of recoverable exceptions. A recoverable exception indicates that the processor can quickly determine the correct state of the incorrect result.

This pipeline apparatus 200 provides many advantages over conventional apparatuses. This apparatus contains fewer stages than similar conventional apparatuses. Fewer stages mean shorter delay and less logic. By removing five stages, this apparatus contains five less latches, which saves area on the chip. Furthermore, this apparatus does not do register comparisons because an incorrect value is not permanently committed to the register file. The incorrect value is rewritten to register file write latch 222 after it has been repaired. This process is more efficient because register comparisons require more logic stages and produce additional delay. The present invention can be utilized in numerous data processing systems. These data processing systems include cell phones, notebook computers, desktop computers, personal digital assistants, handheld computers, and the like.

In addition, for a recoverable exception the state machine 310 (shown in FIG. 3) does not have to produce the architectural state for the program prior to the execution of the instruction that causes the error, and only has to correctly execute the program. This provides more flexibility and efficiency than prior art apparatuses. The state machine has to produce the architectural state of the program prior to the execution of an instruction that could have used the incorrect data. Therefore, only the instructions that mutate incorrect data have to be retried after the incorrect data has been corrected. Fundamentally, it is this architectural state that simplifies the state machine design, so that only the instructions that depend upon the incorrect data need to be retried.

FIG. 3 depicts replay loop 300 of the modified pipeline apparatus. Latches 210 and 226 correspond to the latches in FIG. 2. Replay path 232 and output line 236 also correspond to FIG. 2. In this implementation of correction module 234, MUX 302 provides the correct result. The state machine 310 receives an error detection input 312. This indicates that an error has been detected in the pipeline, and the incorrect result will enter the replay loop 300. Latch 226 transmits the incorrect result to correction module 234 through replay path 232. The incorrect result (on replay path 232) and correct result 306 are inputs to MUX 302. In a preferred embodiment, the memory controller (shown in FIG. 5) provides correct result 306. The state machine 310 selects correct result 306 through input line 304 to MUX 302. Then, MUX 302 transmits the repaired result through output line 236 to latch 210. The state machine 310 selects the replay path 314 for MUX 150, and the repaired result is loaded into latch 210. From there, the repaired result travels down pipeline 200 as described in FIG. 2. FIG. 3 is only used as an example of one preferred embodiment, and does not limit the present invention to this embodiment. For example, XOR gates, alternative MUXs, or similar logic can be implemented to repair the incorrect results from replay path 232.

As previously described, the flush operation sends the remaining results in pipeline 200 down replay path 232, also. Therefore, correction module 234 also outputs the remaining results. If the remaining results are correct, then MUX 302 selects replay path input line 232. If any of the remaining results are incorrect, then MUX 302 selects correct result input line 306. Once again, the state machine 310 controls MUX 302 through select correct result line 304. Accordingly, correction module 234 transmits the repaired result and the remaining results to latch 210. From there the results travel down modified pipeline 200 as described in FIG. 2.

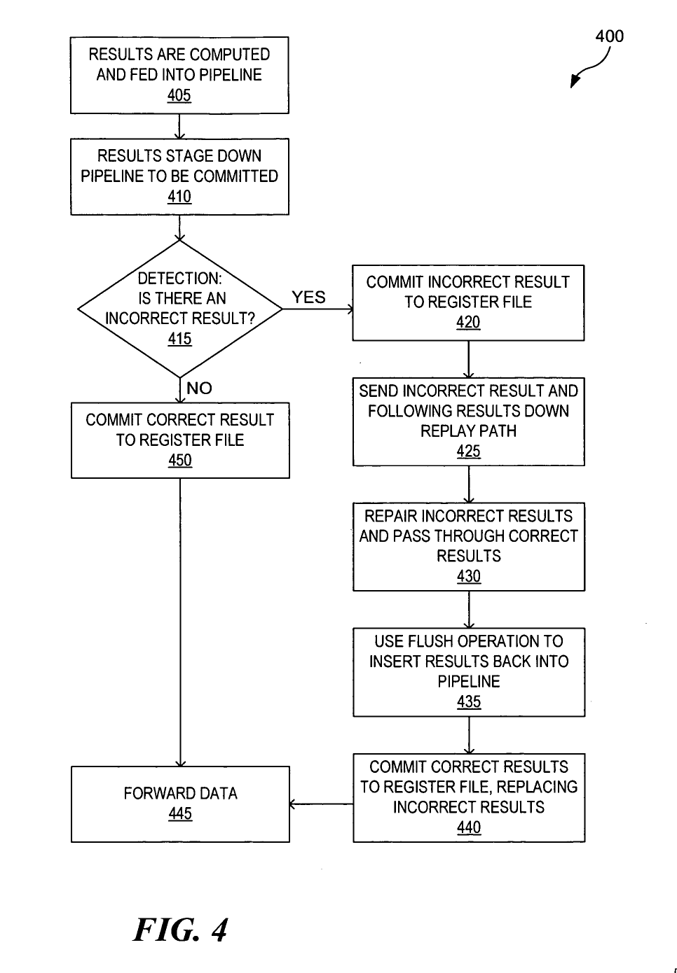

FIG. 4 depicts the modified method to recover the correct state of the processor prior to the execution of a failed instruction by using a replay loop 300. First, the execution units compute the results and feed them into the pipeline 405. The results stage down the pipeline to be committed to the register file 410. While the results are staging down the pipeline, the state machine detects incorrect results 415. If the specific result is correct, then register file write latch 222 commits the correct result to the register file 450. Subsequently, a MUX forwards the data 445.

When the state machine detects an incorrect result, the register file write latch 222 commits the incorrect result to the register file 420. The incorrect result and the following results in the pipeline enter the replay path 425. On the replay path, the correction module repairs the incorrect results and passes through the correct results 430. The state machine 310 (FIG. 3) uses the flush operation to insert the results back into the pipeline 435. Register file write latch 222 commits the correct results to the register file, replacing the incorrect results 440. Subsequently, the MUX forwards the data 445.

FIG. 5 depicts a central processing unit 502 within a computer 500. The central processing unit 502 contains an instruction unit 504, an execution unit 506, a data cache 508, and a memory controller 510. Instruction unit 504 and execution unit 506 have caches. The memory controller 510 issues instructions that are loaded into instruction unit 504. The instruction unit 506 feeds the execution unit 506, where the instructions are executed. The execution unit 506 can retrieve data from the data cache 508 or store data into the data cache 508. Memory controller 510 connects to the data cache 508, also. Memory controller 510 is the component that communicates with the rest of the computer. Accordingly, memory controller connects to external cache 512 and external memory 514.

It is understood that the present invention can take many forms and embodiments. Accordingly, several variations of the present design may be made without departing from the scope of the invention. The capabilities outlined herein allow for the possibility of a variety of programming models. This disclosure should not be read as preferring any particular programming model, but is instead directed to the underlying concepts on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. An apparatus for recovering the correct state of processor instructions in a processor, comprising:
a pipeline of latches, consecutively coupled to each other, that are at least configured to receive, store, and transmit data results;
a register file write latch, coupled to the pipeline of latches and a register file, that is at least configured to commit data results to a register file;
a register file that is at least configured to receive data results from the register file write latch and store data results;
a multiplexor (“MUX”), coupled to the pipeline of latches, that is at least configured to forward data results;
a replay loop, coupled to the pipeline of latches, comprising a correction module that is at least configured to repair incorrect data results and transmit repaired data results into the pipeline of latches; and
means for detecting incorrect results in the pipeline and sending the incorrect results to the replay loop.

2. The apparatus of claim 1, wherein the apparatus further comprises a state machine that is at least configured to detect incorrect data results, send incorrect and correct data results to the replay loop, and control the transmission of correct data results into the pipeline of latches.

3. The apparatus of claim 2, wherein the pipeline of latches are configured to receive data results from execution units within the processor.

4. The apparatus of claim 3, wherein at least one of the latches is coupled to a MUX that is at least configured to select one data result for the latch to store momentarily and to transmit to the next latch in the pipeline.

5. The apparatus of claim 2, wherein the replay loop further comprises:
a replay path coupled to the correction module and the closing stages of the pipeline; and
an output line coupled to the correction module and the beginning stages of the pipeline.

6. The apparatus of claim 5, wherein the correction module comprises a MUX that is at least configured to:
receive inputs of the replay path, a correct result input line, and a select correct result line; and
output correct results to the beginning stages of the pipeline.

7. The apparatus of claim 2, wherein the state machine is at least configured to send an incorrect result followed by a plurality of results to the replay loop.

8. The apparatus of claim 7, wherein the correction module is at least configured to repair incorrect results and pass through correct results.

9. The apparatus of claim 2, wherein the state machine is at least configured to control a flush operation that comprises:
means for ceasing other operations within the pipeline when the incorrect data result enters the replay loop;
means for flushing the plurality of data results in the pipeline to the replay loop;
means for opening the pipeline and inserting the repaired data results into the pipeline; and
means for eliminating any operations within the processor that would utilize the incorrect data results.

10. A method, in a data processing system, for recovering the correct state of processor instructions, containing a pipeline of latches, a register file, and a replay loop, comprising:
staging data results down the pipeline;
detecting incorrect data results within the pipeline;
committing the incorrect data results to the register file;
sending the incorrect data results to the replay loop;
repairing the incorrect data results by the replay loop;
transmitting the repaired data results back into the pipeline;
staging the repaired data results down the pipeline;
committing the repaired data results to the register file to replace the incorrect data results; and
forwarding the repaired data results.

11. The method of claim 10, wherein the staging data results down the pipeline step further comprises transmitting data results to the pipeline by execution units within the processor.

12. The method of claim 10, wherein the committing steps further comprise utilizing a register file latch that is at least configured for:
receiving data results;
storing data results; and
transmitting data results to the register file.

13. The method of claim 10, wherein the sending step further comprises a flush operation for:
sending the incorrect data result to the replay loop;
flushing the following data results within the pipeline to the replay loop;
disabling the pipeline; and
eliminating any operations within the processor that would utilize the incorrect data results.

14. The method of claim 13, wherein the repairing step further comprises repairing incorrect data results and passing through correct data results.

15. The method of claim 14, wherein the transmitting step further comprises opening the pipeline and inserting the repaired data results and the correct data results into the pipeline.

16. The method of claim 15, wherein the staging the repaired data results down the pipeline step further comprises:
enabling the pipeline; and
enabling any operations within the processor that would utilize the repaired data results.

17. The method of claim 13, wherein the committing the repaired data results to the register file to replace the incorrect data results step further comprises committing the following data results to the register file.

18. A processor, comprising:
a pipeline of latches that are at least configured to receive, store, and transmit data results;
a memory controller that is at least configured to detect an incorrect result within the pipeline of latches and provide a correct result for the incorrect result;
a register file coupled to the pipeline of latches, that is at least configured to store data results;
a replay loop coupled to the pipeline of latches, containing a correction module; and
a state machine, which includes logic for performing the following operations:
controlling the correction module to repair incorrect results, and subsequently transmit the repaired results; and
inserting the repaired results into the pipeline of latches.
